(19) United States
(12) Patent Application Publication
(10) Pub. No.: US 2009/0165129 A1
(43) Pub. Date: Jun. 25, 2009

(54) METHOD FOR DELEGATING PRIVILEGES TO A LOWER-LEVEL PRIVILEGE INSTANCE BY A HIGHER-LEVEL PRIVILEGE INSTANCE

(75) Inventors: Uwe WILHELM, Bonn (DE); Katrin JORDAN, Bonn (DE); Stefan SCHRODER, Bonn (DE); Rainer HILLEBRAND, Greven (DE)

Correspondence Address: THE MAXHAM FIRM, 9330 SCRANTON ROAD, SUITE 350, SAN DIEGO, CA, 92121, US

(73) Assignees: T-MOBILE INTERNATIONAL AG, Bonn (DE); DEUTSCHE TELEKOM AG, Bonn (DE)

(21) Appl. No.: 12/340,519

(22) Filed: Dec. 19, 2008

Related U.S. Application Data
(63) Continuation of application No. PCT/EP2007/005364, filed on Jun. 19, 2007.

(30) Foreign Application Priority Data
Jun. 27, 2006 (DE) 10 2006 029 756.3

(51) Int. Cl. G06F 21/00

(52) U.S. Cl. 726/21

(57) ABSTRACT

A method for a higher-level privilege instance to delegate privileges to a lower-level privilege instance, through which the granting of privileges, P1, to a lower-level privilege instance in a data processing device is automatically carried out. The device is provided with functions for setting up required privileges before distribution to a user or by long distance data transmission and, hence, privileges, P1, can be provided to the lower-level privilege instance with the help of a higher-level privilege instance which has special privileges, P2, which authorize the assignment of privileges.

### FIELD OF THE INVENTION

In order to grant controlled privileges to an instance on a device such as a mobile terminal, for example, a higher-level privilege instance which possesses the special privilege for granting privileges sets up the privileges for the lower-level privilege instance on the device.

### DISCUSSION OF THE PRIOR ART

One example of a privilege is the access right to a function of a device. Whether or not the instance possesses the required privilege could be verified, for example, by a cryptographic signature with which the instance is provided. For this purpose, a so-called root certificate for code signing, for example, could be associated with a function, such as reading of a contact list, in the device. If it is possible to successfully verify the signature on the instance using the root certificate, the instance receives the privilege to access the function as needed.

A higher-level privilege instance could be a software application, for example The following process is typically used:

A person, for example an administrator, places a device in a state in which he has the necessary privileges for running a software application by means of which the privileges for a lower-level privilege software application may be set up. This state may also be referred to as the administrative state. The person who uses the lower-level privilege software application is usually not able to place the device in this administrative state. The software application for setting up the privileges is run by the administrator, and the privileges are set up. The administrator removes the device from the administrative state.

The disadvantage of the process customarily used is that an administrator requires physical access to the device. Either the administrator walks or travels to the location of the device, or the device is brought to the administrator. In both cases costs are incurred: in the first case, for the time for which the administrator, on his way to the device or in some transport means such as an automobile or train, is not able to work. In the second case costs are incurred by the loss of use, or also transport, of the device. In both cases additional costs result from the work time required for the individual setting up and administration. There are also expenses for training and the like.

This problem should not be confused with importing an additional root certificate into a browser or the like by the user. The latter is not associated with granting of privileges (authorization) to signed instances, and allows only authentication of signed instances.

European patent publication EP 1353 259 A1 discloses a method for operating a computer system in which an executable main module of a program is installed on the computer system, and module data for the main module and/or for a supplemental module of the program are stored in the computer system. The stored module data contains a license portion, which is necessary for determining the presence of the use authorization of the main and/or supplemental modules, and preferably also contains an information portion. The stored module data are evaluated for acquisition of an additional use authorization for the supplemental module or for an additional supplemental module, and information is provided for acquisition of the use authorization as a function of the evaluation result.

### SUMMARY OF THE INVENTION

A purpose of the invention, therefore, is to provide an improved method for delegating privileges to a lower-level privilege instance by a higher-level privilege instance.

A further purpose of the invention, among other things, is to reduce the complexity and thus the costs for setting up privileges.

### BRIEF DESCRIPTION OF THE DRAWING

The invention is more fully explained by the following detailed description of advantageous embodiments of the same, reference being made to the appended drawing FIGURE, in which:

FIG. 1 shows one preferred sequence of the method according to the invention.

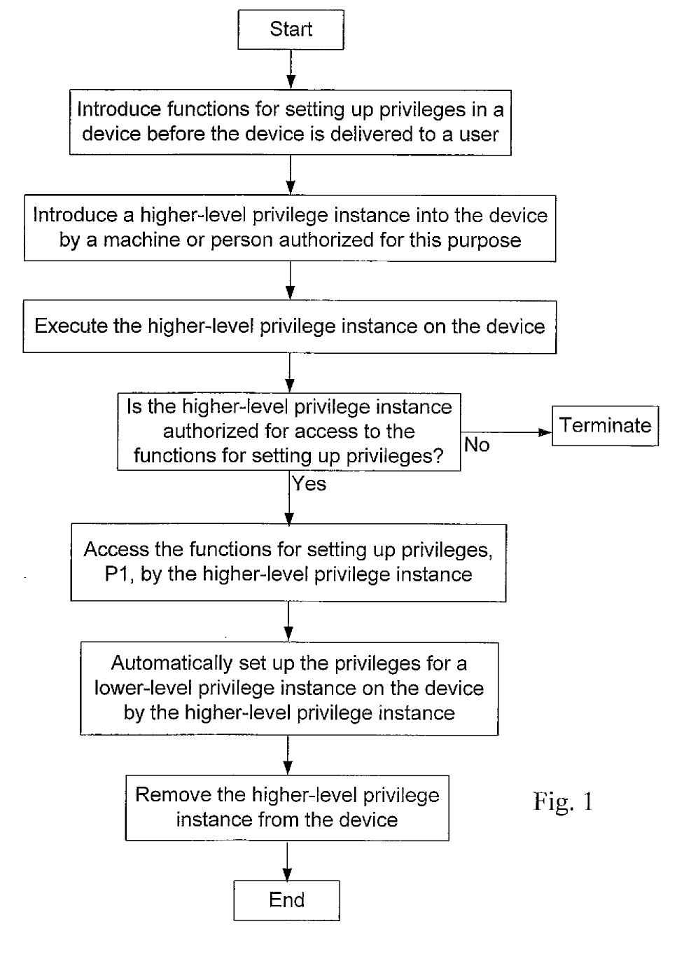

### DETAILED DESCRIPTION OF THE PREFERRED EMBODIMENTS

The method according to embodiments of the invention is based on the fact that the introduction of privileges into devices may be executed automatically and without intervention by an administrator. For this purpose, before delivery to the owner or user the device must be provided with the necessary privileges which are required for a higher-level privilege instance, which is provided with special privileges for the granting of privileges, to set up privileges for lower-level privilege instances.

In order to set up a privilege on a device, a machine or person authorized for this purpose transmits a higher-level privilege instance to the user of the device or directly to the device. In the first case the user introduces the instance into the device. In the second case the instance may already be present in the device, for example, when the device is delivered to the user, or may be transmitted to the device via an air interface. The instance is executed on the device, with or without interaction with the user. On the basis of the cryptographic signature on the instance, for example, the device may verify whether the instance is authorized to set up lower-level privileges for other instances. If this is the case, the instance receives, for example, access to the special functions for setting up privileges. The instance then sets up the privileges without the need for the user to place the device in another state. After the privileges have been successfully set up the instance may be removed from the device.

As a result, after the new privileges are set up, instances which are authorized for this purpose are then able to use these lower-level privileges.

What is claimed is:

1. A method for delegating privileges to a lower-level privilege instance by a higher-level privilege instance, the method comprising:
automatically executing the introduction of privileges, P1, for a lower-level privilege instance in a data processing device;
providing the data processing device with functions for setting up the privileges before delivery to a user or by long distance transmission;
providing a higher-level privilege instance with special privileges, P2, for granting privileges, the higher-level privilege instance having a cryptographic signature; thereby enabling the higher-level privilege instance to set up privileges, P1, for the lower-level privilege instance;
the data processing device verifying, on the basis of the cryptographic signature, whether the higher-level privilege instance is authorized to access the functions for setting up privileges, P1; and
setting up privileges, P1, for a lower-level privilege instance.

2. A method according to claim 1, wherein setting up the privileges, P1, for the lower-level privilege instance comprises:
introducing the higher-level privilege instance into the data processing device by a machine or person authorized for this purpose;
executing the higher-level privilege instance on the data processing device;
accessing the functions for setting up privileges, P1, by the higher-level privilege instance; and
automatically setting up the privileges, P1, for the lower-level privilege instance on the device by the higher-level privilege instance.

3. The method according to claim 1, wherein the higher-level privilege instance is made available to the user and is introduced into the data processing device by the user.

4. The method according to claim 2, wherein the higher-level privilege instance is made available to the user and is introduced into the data processing device by the user.

5. The method according to claim 1, wherein the higher-level privilege instance is already present in the data processing device when the data processing device is delivered to the user, or is transmitted directly to the device via an air interface.

6. The method according to claim 2, wherein the higher-level privilege instance is already present in the data processing device when the data processing device is delivered to the user, or is transmitted directly to the device via an air interface.

7. The method according to claim 1, wherein the higher-level privilege instance is automatically executed in the data processing device.

8. The method according to claim 2, wherein the higher-level privilege instance is automatically executed in the data processing device.

9. The method according to claim 3, wherein the higher-level privilege instance is automatically executed in the data processing device.

10. The method according to claim 5, wherein the higher-level privilege instance is automatically executed in the data processing device.

11. The method according to claim 1, wherein the higher-level privilege instance is executed in the data processing device by an interaction with the user.

12. The method according to claim 2, wherein the higher-level privilege instance is executed in the data processing device by an interaction with the user.

13. The method according to claim 3, wherein the higher-level privilege instance is executed in the data processing device by an interaction with the user.

14. The method according to claim 5, wherein the higher-level privilege instance is executed in the data processing device by an interaction with the user.

15. The method according to claim 1, wherein the higher-level privilege instance is removed from the data processing device after the privileges, P1, for the lower-level privilege instance have been successfully set up.

16. The method according to claim 2, wherein the higher-level privilege instance is removed from the data processing device after the privileges, P1, for the lower-level privilege instance have been successfully set up.

17. A software application having a program code which carries out a method according to claim 1 on a data processing device.

18. A software application having a program code which carries out a method according to claim 2 on a data processing device.

19. A data processing program product which includes a software application which may be run on a data processing device according to claim 1.

20. A data processing program product which includes a software application which may be run on a data processing device according to claim 2.
